(19) United States
(12) Patent Application Publication
(10) Pub. No.: US 2011/0143218 A1
(43) Pub. Date: Jun. 16, 2011

(54) Battery

(76) Inventors: Nikolai N. Issaev, Woodbridge, CT (US); Michael Pozin, Brookfield, CT (US); Michael D. Sliger, New Milford, CT (US)

(21) Appl. No.: 12/637,058

(22) Filed: Dec. 14, 2009

(51) Int. Cl. H01M 6/16

(52) U.S. Cl. 429/333

(57) ABSTRACT

A battery includes an anode having an alkali metal as the active material, a cathode having, for example, iron disulfide as the active material, and an electrolyte containing lithium salts, such as lithium iodide and lithium hexafluorophosphate.

### TECHNICAL FIELD

The invention relates to batteries, as well as to related components and methods.

### BACKGROUND

Batteries or electrochemical cells are commonly used electrical energy sources. A battery contains a negative electrode, typically called the anode, and a positive electrode, typically called the cathode. The anode contains an active material that can be oxidized; the cathode contains or consumes an active material that can be reduced. The anode active material is capable of reducing the cathode active material.

When a battery is used as an electrical energy source in a device, electrical contact is made to the anode and the cathode, allowing electrons to flow through the device and permitting the respective oxidation and reduction reactions to occur to provide electrical power. An electrolyte in contact with the anode and the cathode contains ions that flow through the separator between the electrodes to maintain charge balance throughout the battery during discharge.

One type of battery includes an alkali metal as the anode active material and iron disulfide as the cathode active material.

### SUMMARY

In general, the invention relates to batteries including an anode, a cathode, and an electrolyte including one or more lithium salts and a combination of solvents. In one aspect, the batteries have an anode including lithium-containing anode active material; a cathode including a transition metal sulfide, and an electrolyte including lithium iodide and lithium hexafluorophosphate, in a solvent including 1,3-dioxolane and 1,2-dimethoxyethane. The electrolyte can include one or more additives, such as 3,5-dimethylisoxazole, pyridine, and/or water. The electrolyte can provide batteries with good safety characteristics, good stability, good high and medium current discharge properties, and cost benefits. The electrolyte can have relatively low viscosity and good conductivity.

In one aspect, the invention features a battery including a housing. The housing includes an anode including a lithium-containing anode active material, a cathode including a transition metal sulfide or a transition metal oxide, and an electrolyte including between 0.05 M and 0.5 M lithium iodide, between 0.05 M and 0.5 M lithium hexafluorophosphate, 30% by weight or more 1,3-dioxolane, and 20% by weight or more 1,2-dimethoxyethane.

Embodiments of the battery may include one or more of the following features.

The cathode can include FeS₂, FeS, and/or CuS.

The electrolyte can further include water (e.g., less than 500 ppm water, 250 ppm or less water, or 100 ppm or less water; between 50 ppm and 500 ppm water, between 100 and 400 ppm water, or between 200 and 300 ppm water). The electrolyte can include an additive, such as 3,5-dimethylisoxazole or pyridine, at an amount of between 500 ppm and 5000 ppm (e.g., between 1000 ppm and 5000 ppm, between 2000 and 4000 ppm, between 3000 ppm and 4000 ppm).

The electrolyte can include between 0.05 M and 0.3 M (between 0.05 M and 0.4 M, between 0.05 M and 0.3 M, between 0.1 M and 0.4 M, between 0.1 M and 0.3 M, between 0.1 M and 0.25 M, or between 0.1 M and 0.2 M) LiI or LiPF₆. In some embodiments, the electrolyte preferably includes between 0.1 M and 0.3 M of lithium iodide, and between 0.1 M and 0.3 M lithium hexafluorophosphate. The total salt concentration in the electrolyte can be at least about 0.05 M (e.g., at least 0.1 M, at least about 0.3 M, at least about 0.5 M, or at least about 0.7 M) and/or up to about one molar (M) (e.g., up to about 0.8 M, up to about 0.5 M, up to about 0.3 M, or up to 0.1 M). The electrolyte can include 70% by weight 1,3-dioxolane and/or 30% by weight 1,2-dimethoxyethane.

In some embodiments, the electrolyte has a viscosity of between 0.6 and 0.8 cps (e.g., between 0.7 and 0.8 cps). The electrolyte can have a resistivity of between 100 and 600 ohm·cm (e.g., between 150 and 600 ohm·cm, between 150 and 400 cm, or between 200 and 400 ohm·cm). The battery has a specific discharge capacity of 3.86 Ah or less after predischarge. The housing can further include a separator having a porosity of between 35% and 65%.

The details of one or more embodiments of the invention are set forth in the accompanying drawings and the description below. Other features and advantages will be apparent from the detailed description, the drawings, and from the claims.

### DESCRIPTION OF DRAWINGS

FIG. 1 is a sectional view of an embodiment of a non-aqueous electrochemical cell.

FIG. 2 is a graph showing resistivities of embodiments of electrolyte compositions.

### DETAILED DESCRIPTION

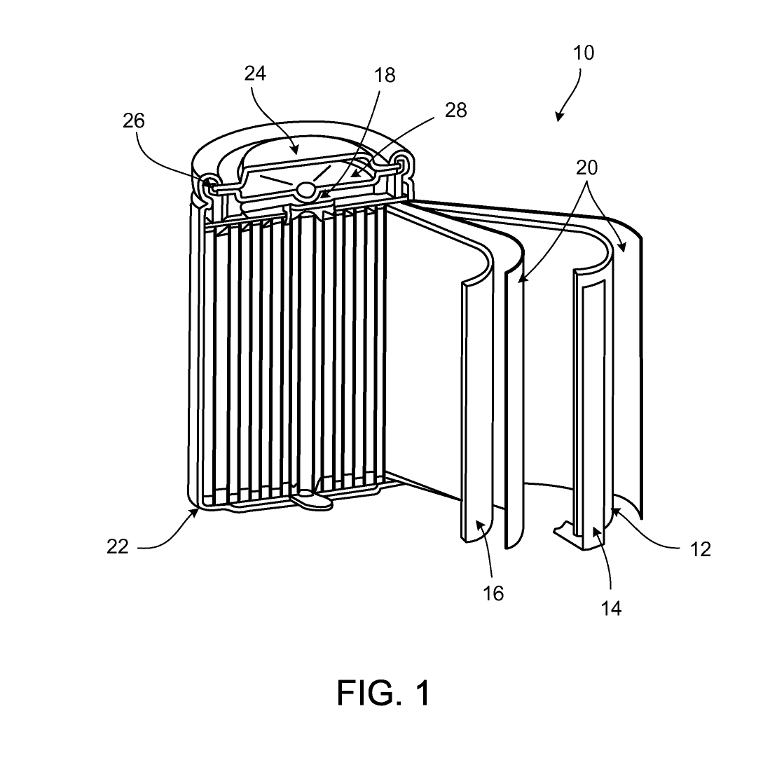

Referring to FIG. 1, a primary electrochemical cell 10 includes an anode 12 in electrical contact with a negative lead 14, a cathode 16 in electrical contact with a positive lead 18, a separator 20, and an electrolyte. Anode 12, cathode 16, separator 20, and the electrolyte are contained within a case 22. The electrolyte can include salts, such as lithium iodide and lithium hexafluorophosphate, at least partially dissolved in a mixture of solvents, such as 1,3-dioxolane (DX), and 1,2-dimethoxyethane (DME). Electrochemical cell 10 further includes a cap 24 and an annular insulating gasket 26, as well as a safety valve 28.

Cathode 16 includes a cathode current collector and a cathode material that is coated on at least one side of the cathode current collector. The cathode material includes the cathode active material(s) and can also include one or more conductive materials (e.g., conductive aids, charge control agents) and/or one or more binders.

The cathode active material includes one or more transition metal sulfide having the formula MₘSₙ, wherein M is a transition metal, m is at least 1, and n is at least 1. In some embodiments, n is 2. In other embodiments, n is greater than 2.5 or 3.0. Examples of transition metals include iron and copper. Examples of transition metal sulfides include FeS₂, FeS, CuS, CoS₂, NiS₂, MoS₂, CO₂S₉, CO₂S₇, Ni₂S₇, Fe₂S₇, Mo₂S₃. In some embodiments, the cathode active material includes mixed metal sulfides, such as NiCoS₇. Transition metal sulfides are further described, for example, in Bowden et al., U.S. Pat. No. 4,891,283 and Bowden et al., U.S. Pat. No. 4,481,267. The cathode material includes, for example, at least about 85% by weight and/or up to about 99% by weight of cathode active material.

The conductive materials can enhance the electronic conductivity of cathode 16 within electrochemical cell 10. Examples of conductive materials include conductive aids and charge control agents. Specific examples of conductive materials include carbon black, graphitized carbon black, acetylene black, and graphite. The cathode material includes, for example, at least about 3% by weight and up to about 8% by weight of one or more conductive materials.

The binders can help maintain homogeneity of the cathode material and can enhance the stability of the cathode. Examples of binders include linear di- and tri-block copolymers. Additional examples of binders include linear tri-block polymers cross-linked with melamine resin; ethylene-propylene copolymers; ethylene-propylene-diene terpolymers; tri-block fluorinated thermoplastics; fluorinated polymers; hydrogenated nitrile rubber; fluoro-ethylene-vinyl ether copolymers; thermoplastic polyurethanes; thermoplastic olefins; styrene-ethylene-butylene-styrene block copolymers; and polyvinylidene fluoride homopolymers. The cathode material includes, for example, at least about 0.5% by weight (e.g., at least about 1% by weight, at least about 2% by weight, at least about 3% by weight, at least about 4% by weight) and/or up to about 5% by weight (e.g., up to about 4% by weight, up to about 3% by weight, up to about 2% by weight, or up to about 1% by weight) of one or more binders.

The cathode current collector can be formed, for example, of one or more metals and/or metal alloys. Examples of metals include titanium, nickel, and aluminum. Examples of metal alloys include aluminum alloys (e.g., 1N30, 1230) and stainless steel. The current collector generally can be in the form of a foil or a grid. The foil can have, for example, a thickness of up to about 35 microns (e.g., up to about 30 microns, up to about 25 microns) and/or at least about 15 microns (e.g., at least about 25 microns, at least about 30 microns).

Cathode 16 can be formed by first combining one or more cathode active materials, conductive materials, and binders with one or more solvents to form a slurry (e.g., by dispersing the cathode active materials, conductive materials, and/or binders in the solvents using a double planetary mixer), and then coating the slurry onto the current collector, for example, by extension die coating or roll coating. The coated current collector is then dried and calendered to provide the desired thickness and porosity.

Anode 12 includes one or more alkali metals (e.g., lithium, sodium, potassium) as the anode active material. The alkali can be a pure metal or an alloy of the metal. In some embodiments, lithium is the preferred metal; lithium can be alloyed, for example, with an alkaline earth metal or aluminum. In some embodiments, the alkali metal is alloyed with one or more of Mg, Ga, Ca, Bi, In, Sn, and Si. The preferred lithium metal is lithium alloyed with aluminum. The lithium alloy may contain, for example, at least about 500 ppm and up to about 5000 ppm (e.g., at least about 1000 ppm and up to 2000 ppm, or at least about 1200 ppm and up to about 1700 ppm) of aluminum or other alloyed material. The lithium alloy can be incorporated into the battery in the form of a foil.

Alternatively, anode 12 can include a particulate material such as lithium-insertion compound, for example, LiC₆, Li₄Ti₅O₁₂, LiTiS₂. In these embodiments, anode 12 can include one or more binders. Examples of binders include polyethylene, polypropylene, EPDM, styrene-butadiene rubbers, and polyvinylidene fluoride (PVDF). The anode composition includes, for example, at least about 0.5% by weight and up to about 9% by weight of binder. To form the anode, the anode active material and one or more binders can be mixed to form a paste which can be applied to a substrate. After drying, the substrate optionally can be removed before the anode is incorporated into the housing.

The anode material includes, for example, at least about 90% by weight and up to about 100% by weight of anode active material.

The electrolyte preferably is in liquid form. The electrolyte includes one or more solvents. In some embodiments, the electrolyte includes 1,2-dimethoxyethane (DME) and/or 1,3-dioxolane (DX). The electrolyte includes, for example, 15% or more (e.g., 20 or more, 25% or more, or 30% or more) and/or 40% or less (e.g., 30% or less, 25% or less, or 20% or less) by weight of 1,2-dimethoxyethane. In some embodiments, the electrolyte includes between 15% and 40% (e.g., between 20% and 40%, between 30 and 40%, 20%, 25%, or 30%) by weight of 1,2-dimethoxyethane. Without wishing to be bound by theory, it is believed that 1,2-dimethoxyethane can reduce the viscosity of the electrolyte to the desired target.

The electrolyte can contain 20% or more (e.g., 30% or more, 50% or more, 60% or more, or 70% or more) and/or 80% or less (e.g., 70% or less, 60% or less, 50% or less, or 30% or less) by weight of 1,3-dioxolane. In some embodiments, the electrolyte includes between 20% and 80% (e.g., between 30% and 70%, between 50 and 70%, between 60 and 70%, between 60% and 80%, 60%, 70%, 75%) by weight of 1,3-dioxolane. Without wishing to be bound by theory, it is believed that 1,3-dioxolane can promote solubility of electrolyte salts, for example, at lower temperatures.

In some embodiments, the electrolyte contains 500 ppm or more (e.g., 1000 ppm or more, 2000 ppm or more, 3000 ppm or more, or 4000 ppm or more) and/or 5000 ppm or less (e.g., 4000 ppm or less, 3000 ppm or less, 2000 ppm or less, or 1000 ppm or less) 3,5-dimethylisoxazole. The electrolyte can include between 500 ppm and 5000 ppm (e.g., between 1000 ppm and 5000 ppm, between 2000 and 4000 ppm, between 3000 ppm and 4000 ppm, 2000 ppm, 3000 ppm, 4000 ppm, or 5000 ppm) of 3,5-dimethylisoxazole. Without wishing to be bound by theory, it is believed that 3,5-dimethylisoxazole is an additive, and can suppress polymerization of dioxolane.

In some embodiments, the electrolyte can include pyridine as an additive. For example, the electrolyte can include between 500 ppm and 5000 ppm (e.g., between 1000 ppm and 5000 ppm, between 2000 and 4000 ppm, between 3000 ppm and 4000 ppm, 2000 ppm, 3000 ppm, 4000 ppm, or 5000 ppm) pyridine. The electrolyte can include 500 ppm or more (e.g., 1000 ppm or more, 2000 ppm or more, 3000 ppm or more, or 4000 ppm or more) and/or 5000 ppm or less (e.g., 4000 ppm or less, 3000 ppm or less, 2000 ppm or less, or 1000 ppm or less) pyridine. Without wishing to be bound by theory, it is believed that pyridine can suppress polymerization of dioxolane.

In some embodiments, the electrolyte further includes water. For example, the electrolyte can include between 10 and 1000 ppm (e.g., between 50 ppm and 1000 ppm, between 50 ppm and 500 ppm, between 100 and 400 ppm, between 200 and 300 ppm, 50 ppm, 100 ppm, 200 ppm, 300 ppm, 400 ppm, or 500 ppm) of water. In some embodiments, the electrolyte can include 50 ppm or more (e.g., 100 ppm or more, 250 ppm or more, or 500 ppm or more) and/or 1000 ppm or less (e.g., 500 ppm or less, 250 ppm or less, or 100 ppm or less) of water. Water content is determined via standard Karl Fisher titration methods, with adjustments for iodine. Karl Fisher titration methods is described, for example, in Bruttel P. and Schlink R., Water Determination by Karl Fisher Titration, Metrohm Ion Analysis monograph, 2003. Iodine adjustment is performed by weighing an amount of an electrolyte sample into a beaker, adding a second amount of 0.5 wt % starch solution into the beaker, titrating the electrolyte sample with 0.9 mM sodium thiosulphate solution until the blue color changes to white, and calculating the moles of sodium thiosulphate consumed for the titration. The moles of iodine in the electrolyte (e.g., when the electrolyte contains LiI) is equivalent to half of the consumed sodium thiosulphate. The iodine concentration can be calculated based on the following formula:

Iodine (ppm)=mole of iodine×254/weight of electrolyte.

The amount of water in electrolyte is adjusted for the concentration of iodine present in electrolyte based on the formula: formula weight of water/formula weight of iodine×100=7.1%.

In some embodiments, the electrolyte includes other solvents. For example, the electrolyte can include, tetrahydrofuran (THF), acetonitrile (AN), gamma-butyrolactone (GBL), diethyl carbonate (DEC), dimethyl carbonate (DMC), ethyl methyl carbonate (EMC) dimethylsulfoxide (DMSO), 3-methyl-2-oxazolidinone, methyl formate (MF), sulfolane (SU), acyclic ether-based solvent such as dimethoxyethane, ethyl glyme, diglyme, dimethoxypropane (DMP), triglyme, or combinations thereof.

The electrolyte can include one or more salts. Preferred lithium salts include lithium iodide (LiI) and lithium hexafluorophosphate (LiPF₆). Examples of other salts include lithium bis(trifluoromethanesulfonyl)imide (LiTFSI), lithium trifluoromethanesulfonate (LiTFS), lithium bis(oxalato) borate (LiB(C₂O₄)₂), and lithium bis(perfluoroethyl)sulfonimide (LiN(SO₂C₂F₅)₂). In some embodiments, the electrolyte includes other additional salts. For example, the electrolyte can include corrosion inhibitors such as lithium perchlorate (LiCO₄) and/or lithium nitrate (LiNO₃). The additional salts can include LiTFS, LiI, LiBr, LiTFSI, LiBF₄, LiPF₆, LiAsF₆, LiBOB, Li(CF₃SO₂)₂N, Li(CF₃SO₂)₃C, and combinations thereof. Electrolyte salts are described, for example, in Suzuki et al., U.S. Pat. No. 5,595,841 and in Totir et al., U.S. Pat. App. Pub. 2005/0202320 A1. The electrolyte includes, for example, at least about 0.05 M (e.g., at least 0.1 M, at least about 0.3 M, at least about 0.5 M, or at least about 0.7 M) and/or up to about one molar (e.g., up to about 0.8 M, up to about 0.5 M, up to about 0.3 M, or up to 0.1 M) in total salt concentration.

In some embodiments, when the lithium salt is LiI, the electrolyte includes between 0.05 M and 0.5 M (e.g., between 0.05 M and 0.4 M, between 0.05 M and 0.3 M, between 0.1 M and 0.4 M, between 0.1 M and 0.3 M, between 0.1 M and 0.25 M, or between 0.1 M and 0.2 M, 0.1 M, 0.2 M, 0.25 M, or 0.3 M) of LiI. For example, the electrolyte can include 0.05 M or more (e.g., 0.1 M or more, 0.15 M or more, 0.2 M or more, 0.25 M or more, 0.3 M or more, or 0.4 M or more) and/or 0.5 M or less (e.g., 0.4 M or less, 0.3 M or less, 0.25 M or less, 0.2M or less, 0.15 M or less, or 0.1 M or less) of LiI. The electrolyte preferably includes between 0.1 M and 0.3 M of lithium iodide.

In some embodiments, when the lithium salt is LiPF₆, the electrolyte includes between 0.05 M and 0.5 M (e.g., between 0.05 M and 0.4 M, between 0.05 M and 0.3 M, between 0.1 M and 0.4 M, between 0.1 M and 0.3 M, between 0.1 M and 0.25 M, or between 0.1 M and 0.2 M, 0.1 M, 0.2 M, 0.25 M, or 0.3 M) of LiPF₆. For example, the electrolyte can include 0.05 M or more (e.g., 0.1 M or more, 0.2 M or more, 0.25 M or more, 0.3 M or more, or 0.4 M or more) and/or 0.5 M or less (e.g., 0.4 M or less, 0.3 M or less, 0.25 M or less, 0.2 M or less, or 0.1 M or less) of LiPF₆. The electrolyte preferably includes between 0.1 M and 0.3 M lithium hexafluorophosphate. In some embodiments, when the electrolyte includes LiPF₆ and LiI, the LiPF₆ can replace some of the LiI to improve conductivity and provide good cost benefits. In some embodiments, addition of LiI can suppress formation of LiPF₆ decomposition products, such as PF₅ and HF.

An electrolyte composition including a combination of LiI and LiPF₆ salts can have relatively good electrolytic and electrical conductivity, stability, good mass transport properties, and good storage capabilities (e.g., at a temperature of between 0 and 60° C.). The electrolyte composition can have relatively good high and medium rate performance at relatively low cost. In some embodiments, when the electrolyte composition includes LiI and LiPF₆ salts, the salts can be dissolved in a solvent mixture of 1,2-dimethoxyethane, 1,3-dioxolane, and 3,5-dimethylisoxazole. For example, the solvent mixture can include between 60 and 75% by weight 1,3-dioxolane, between 25-40% by weight 1,2-dimethoxyethane, and between 1000 ppm and 3000 ppm 3,5-dimethylisoxazole.

The electrolyte has a viscosity, for example, of at least 0.2 centipoise (cps) (e.g., at least 0.4 cps, at least 0.6 cps, at least 0.8 cps, at least 1.2 cps, at least 1.6 cps) and up to 2.5 cps (e.g., up to 2 cps, up to 1.6 cps, up to 1.2 cps, up to 0.8 cps, up to 0.6 cps, or up to 0.4 cps). For example, the viscosity can be between 0.4 and one cps (e.g., between 0.4 and 0.8 cps, between 0.6 and one cps, between 0.6 and 0.8 cps, between 0.7 and 0.8 cps, between 0.6 and 0.85 cps, between 0.7 and 0.85 cps). As used herein, viscosity is measured as standard techniques with a Cannon-Fenske Viscometer #50, at 25° C. An electrolyte having a relatively low viscosity can have enhanced mass transport, and can have relatively greater conductivity.

The electrolyte has a density at 25° C., for example, of one g/cm³ or more (e.g., 1.1 g/cm³ or more) and/or 1.2 g/cm³ or less (e.g., 1.1 g/cm³ or less). In some embodiments, the density is between one g/cm³ and 1.2 g/cm³ (e.g., between one g/cm³ and 1.1 g/cm³). An electrolyte having relatively low density can have enhanced mass transport and relatively greater conductivity. Density is calculated by multiplying the specific gravity of an electrolyte by the density of water at the same temperature, and is measured using a pycnometer and an analytical balance having 0.0001 g accuracy, at 25° C., as described, for example, in American Institute of Physics Handbook, 3^{rd} Ed., D. E. Gray, Editor, McGraw-Hill, NY (1972), 2-152 to 2-153.

Positive lead 18 can include stainless steel, aluminum, an aluminum alloy, nickel, titanium, or steel. Positive lead 18 can be annular in shape, and can be arranged coaxially with the cylinder of a cylindrical cell. Positive lead 18 can also include radial extensions in the direction of cathode 16 that can engage the current collector. An extension can be round (e.g., circular or oval), rectangular, triangular or another shape. Positive lead 18 can include extensions having different shapes. Positive lead 18 and the current collector are in electrical contact. Electrical contact between positive lead 18 and the current collector can be achieved by mechanical contact. In some embodiments, positive lead 18 and the current collector can be welded together.

Separator 20 can be formed of any of the standard separator materials used in electrochemical cells. For example, separator 20 can be formed of polypropylene (e.g., nonwoven polypropylene, microporous polypropylene), polyethylene, and/or a polysulfone. Separators are described, for example, in Blasi et al., U.S. Pat. No. 5,176,968. The separator may also be, for example, a porous insulating polymer composite layer (e.g., polystyrene rubber and finely divided silica), or microporous extruded or cast films (membranes). In some embodiments, separators produced from microfibers, such as by melt blown nonwoven film technology, can be used. Such films typically possess pores of several microns in diameter but have less tortuous paths.

In some embodiments, the separator can have a thickness of between 8 μm and 25 μm (e.g., between 10 μm and 25 μm, between 15 μm and 25 μm, between 10 μm and 20 μm, or between 20 μm and 25 μm). In some embodiments, the separator includes a porosity of between 35% and 70% (e.g., between 37% and 70%, between 37% and 65%, between 40% and 60%, or between 45% and 55%). A minimum porosity of 35% can typically be utilized to provide moderate ion transport. Porosities greater than 70% can result in insufficient tensile strength for processing into an electrochemical cell and the need for thicker than desired separators. Preferred separator porosities can be between about 35% and about 65%.

In some embodiments, in addition to an electrolyte including salts, such as lithium iodide and lithium hexafluorophosphate, at least partially dissolved in a mixture of solvents, such as 1,3-dioxolane (DX) and 1,2-dimethoxyethane (DME), a low resistance separator further provides optimal high rate cell performance. A separator material can include microporous extruded or cast films (membranes). The microporous membrane separator can have an average pore size range from about 0.005 to about 5 microns and preferably from about 0.005 to about 0.3 microns, a porosity range from about 30 to about 70 percent, preferably from about 35 to about 65 percent, an area specific resistance measured in combination with the electrolyte of less than 25 ohm·cm², and a tortuosity of less than about 2.5.

The pore size of the separator can be above a minimum value which enables the nonhindered migration of a solvated ion. In some embodiments, the separator has a minimum pore diameter of 0.005 micron to enable the nonimpeded passage of an ion through a pore, and/or to accommodate the presence of ion pairs and/or a monolayer of electrolyte solvent lining the pore walls. As the pore size increases, nonporous areas can also increase in order to provide mechanical strength. Typically, in separators having pores of submicron size, the distance between pores can also be less than a micron.

The separator can also function as a physical barrier to the passage of electrode particles through the separator which can result in an electrical short between the anode and cathode. Such particles can be as small as a few microns, thus also limiting the upper pore diameter. Consequently the pore size can preferably be in the submicron range (e.g., less than one micron) or the pores should be sufficiently tortuous to provide a physical barrier to the passage of electrode particles through the separator.

Methods for determining pore size of a porous material are liquid displacement and air flow measurements. These measurements can be performed using a commercial instrument such as the Coulter II Porometer. The Coulter II Porometer determines the pressure required to overcome the surface tension of a liquid within a wetted pore. The smaller the pore, the greater the pressure required. By comparing the pressure profile of a wetted membrane to a dry membrane, a pore diameter distribution can be determined. Pore diameters represent mean pore flow diameters, that is, half of the flow passes through pores larger than this value and half flows through pores smaller than this diameter.

Area specific resistance is a measured combination of separator and electrolyte property which is influenced by properties such as pore size, number of pores, porosity, tortuosity and wettability. The area specific resistance value can correlate to electrochemical cell rate capability. In lithium cells having organic electrolytes and solid cathodes, the preferred area specific resistance value for high rate performance can be less than 25 ohm·cm². Separator and electrolyte area specific resistance above 25 ohm·cm² can hinder the rate performance capability of the cell.

Tortuosity in its simplest definition is the ratio of actual pore length, i.e., how far an ion has to travel to pass through a separator, to the separator thickness. However this definition assumes that mass transport through a pore is affected only by distance and does not take other hindrances to mass transport into account. Such hindrances include: pore bottle necks or pore restrictions, noninterconnected pores or dead ends, inhibited ion flow as ions collide with pore side walls at channel bends. Separator tortuosity can be estimated from the measured resistance value in electrolyte. The most common method of determining the effective tortuosity of a separator is based on the separator porosity and the ratio of specific conductivity of the separator to that of the electrolyte. Thus,

$$\frac{{R}_{separator}}{{R}_{solution}} = \frac{{Tortuosity}^{2}}{Porosity}$$

where Rₛₑₚₐᵣₐₜₒᵣ is the area specific resistance in ohms-cm² of the separator, Rₛₒₗᵤₜᵢₒₙ is the area specific resistance in ohms-cm² of the electrolyte and porosity in volume fraction. Although this equation assumes all pores have identical tortuosities, it is accurate for defining the separator of this invention. It has been found that the best high rate separators exhibit tortuosities of less than 2.5 and preferably less than 2.0.

Case 22 can be made of, for example, one or more metals (e.g., aluminum, aluminum alloys, nickel, nickel plated steel, stainless steel) and/or plastics (e.g., polyvinyl chloride, polypropylene, polysulfone, ABS, polyamide).

Cap 24 can be made of, for example, aluminum, nickel, titanium, or steel.

While electrochemical cell 10 in FIG. 1 is a primary cell, in some embodiments a secondary cell can have a cathode that includes the above-described cathode active material. Primary electrochemical cells are meant to be discharged (e.g., to exhaustion) only once, and then discarded. Primary cells are not intended to be recharged. Primary cells are described, for example, in David Linden, Handbook of Batteries (McGraw-Hill, 2d ed. 1995). Secondary electrochemical cells can be recharged for many times (e.g., more than fifty times, more than a hundred times, or more). In some cases, secondary cells can include relatively robust separators, such as those having many layers and/or that are relatively thick. Secondary cells can also be designed to accommodate for changes, such as swelling, that can occur in the cells. Secondary cells are described, for example, in Falk & Salkind, “Alkaline Storage Batteries”, John Wiley & Sons, Inc. 1969, and DeVirloy et al., U.S. Pat. No. 345,124.

To assemble the cell, separator 20 can be cut into pieces of a similar size as anode 12 and cathode 16 and placed therebetween. Anode 12, cathode 16, and separator 20 are then placed within case 22, which is then filled with the electrolytic solution and sealed. One end of case 22 is closed with cap 24 and annular insulating gasket 26, which can provide a gas-tight and fluid-tight seal. Positive lead 18 connects cathode 16 to cap 24. Safety valve 28 is disposed in the inner side of cap 24 and is configured to decrease the pressure within electrochemical cell 10 when the pressure exceeds some predetermined value. Methods for assembling an electrochemical cell are described, for example, in Moses, U.S. Pat. No. 4,279,972, Moses et al., U.S. Pat. No. 4,401,735, and Kearney et al., U.S. Pat. No. 4,526,846.

After assembly, the battery can be subjected to various performance tests, such as a motorized toy test, a remote control test, a wireless game controller test, a portable light test, a digital camera test, a CD player test, and/or a radio test. The test battery can have similar or superior performance (e.g., about 0.5% or greater, about 3% or greater, about 6% or greater, or about 12% or greater) compared to a battery including an electrolyte having only LiI salt, at a higher concentration compared to the sum of salt concentrations in the electrolyte of the test battery.

The electrolyte can have a resistivity of between 100 and 600 ohm·cm (e.g., between 150 and 600 ohm·cm, between 150 and 400 ohm·cm, between 150 and 400 ohm·cm, between 200 and 400 ohm·cm) at 20° C. In some embodiments, the resistivity is 100 ohm·cm or more (e.g., 150 ohm·cm or more, 200 ohm·cm or more, 250 ohm·cm or more, or 400 ohm·cm or more) and/or 600 ohm·cm or less (e.g., 400 ohm·cm or less, 250 ohm·cm or less, 200 ohm·cm or less, or 150 ohm·cm or less). The electrolyte can provide a battery with a relatively low resistivity, which can increase battery performance. Resistivity of the electrolyte can be measured by using a conductivity cell (Model 3403 cell K=1/0 cm. SN: 02H0081 AC. YSI Incorporated, Yellow Springs, Ohio 45387 USA) at 20° C. in a Tenney Jr. thermal chamber.

In some embodiments, the battery can have a calculated theoretical specific discharge capacity of 3.86 Ah or less (e.g., 3.6 Ah or less, 3.4 Ah or less) and/or 3.2 Ah or more (e.g., 3.4 Ah or more, 3.6 Ah or more) after predischarge.

Other configurations of an electrochemical cell can also be used, including, for example, the button or coin cell configuration, the prismatic cell configuration, the rigid laminar cell configuration, and the flexible pouch, envelope or bag cell configuration. Furthermore, an electrochemical cell can have different voltages (e.g., 1.5 V, 3.0 V, 4.0 V). Electrochemical cells having other configurations are described, for example, in Berkowitz et al., U.S. Ser. No. 10/675,512, U.S. Pat. App. Pub. 2005/0112467 A1, and Totir et al., U.S. Pat. App. Pub. 2005/0202320 A1.

The following examples are meant to be illustrative and not to be limiting.

### Example 1

### Density and Viscosity of Electrolytes

Two control electrolytes and two experimental electrolytes were prepared. Compositions of the electrolytes and their respective measured densities and viscosities are presented in Table 1.

TABLE 1
Density and viscosities of electrolyte compositions.

| | | Viscosity | Density |
|---|---|---|---|
| Electrolyte | Composition | (cps) | (g/ml) |
| Control A | 0.75M LiI in 70/30 DX/DME by | 0.824 | 1.082 |
| | weight, plus 2000 ppm DMI | | |
| Control B | 0.45M LiI in 70/30 DX/DME by | 0.726 | 1.040 |
| | weight, plus 2000 ppm DMI | | |
| Electrolyte I | 0.25M LiI + 0.25M LiPF₆ in | 0.743 | 1.054 |
| | 70/30 DX/DME by weight, plus | | |
| | 2000 ppm DMI | | |
| Electrolyte II | 0.15M LiI + 0.15M LiPF₆ in | 0.689 | 1.030 |
| | 70/30 DX/DME by weight, plus | | |
| | 2000 ppm DMI | | |

The density and viscosity of experimental electrolytes were significantly lower compared to the control electrolytes. For example, Electrolyte I had a viscosity that is about 10% lower and a density that is about 2.5% lower than the viscosity and density values for Control A. Further, Electrolyte II had a viscosity that is 5% lower, and a density that is 1% lower than the viscosity and density values for Control B. Density was determined using a pycnometer at 25° C. Viscosity is measured using standard techniques with a Cannon-Fenske Viscometer #50, at 25° C.

### Example 2

### Resistivity Measurements

Experiments were conducted on two control electrolytes and two experimental electrolytes. The electrolyte composition and resistivity at 20° C. are presented in Table 2.

TABLE 2
Resistivities of electrolyte compositions.

| | | Resistivity (20° C., |
|---|---|---|
| Electrolyte | Composition | ohm · cm) |
| Control A | 0.75M LiI in 70/30 DX/DME, plus | 162.7 |
| | 2000 ppm DMI | |
| Control B | 0.45M LiI in 70/30 DX/DME, plus | 326.9 |
| | 2000 ppm DMI | |
| Electrolyte I | 0.25M LiI + 0.25M LiPF₆ in 70/30 | 152.0 |
| | DX/DME, plus 2000 ppm DMI | |
| Electrolyte II | 0.15M LiI + 0.15M LiPF₆ in 70/30 | 309.0 |
| | DX/DME, plus 2000 ppm DMI | |

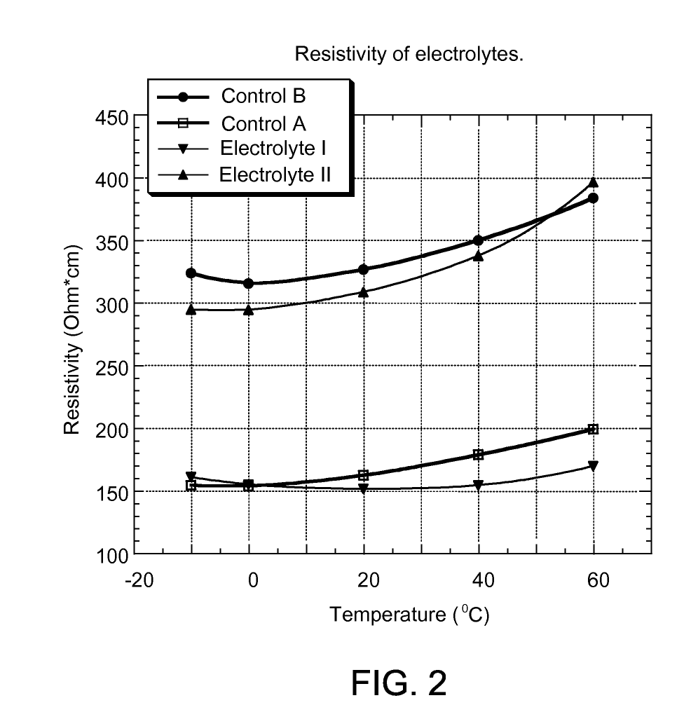

Experimental results were obtained using electrochemical techniques in a glass cell (measurements of electrolyte's resistivity). For example, resistivity of electrolyte was measured using a conductivity cell (Model 3403 cell K=1/0 cm. SN: O₂H0081 AC. YSI Incorporated, Yellow Springs, Ohio 45387 USA). Calibration of conductivity cell was performed using 1M KCl solution at 20° C. in a Tenney Jr. thermal chamber. The calculated cell constant was 0.994. Resistivity measurements were also conducted at 20° C. in a Tenney Jr. thermal chamber. Further, resisitivity measurements at different temperatures are shown in FIG. 2.

### Example 3

### Performance

The AA cells were built according to the standard procedures for fabricating Li/FeS₂ AA cells, for example, as described in U.S. application Ser. No. 12/129,158, filed May 29, 2009. Performance of cells were evaluated using selected ANSI/IBC tests for both fresh and stored cells.

Wound AA size cells were prepared using a lithium foil anode 0.157 mm in thickness, 39 mm wide and about 310 mm long, having an approximate weight of 1.0 grams (available from FMC Corp Lithco Div.), and a cathode consisting of finely divided FeS₂ 89.2% (Chemetall) adhered to an aluminum foil (Allfoils) with small amounts of carbon (1% Super P MMM Carbon), graphite 7% (KS-6 Timcal Graphite) and a polystyrene binder (KRATON™ G1651) 3% having a typical weight of about 6.7 grams and a thickness of 0.185 mm. The separator was Celgard 2400 (Celgard).

The electrolytes from Example 1 were separately incorporated into AA size cells. From 1.7 to 2.1 grams of a specific electrolyte were placed in each cell. The cells were then crimped and pre-discharged.

Battery performance tests were carried out. For example, in the digital camera test, the cells were then discharged on the digital camera test consisting of applying a 1500 mW drain for 2 seconds followed by 650 mW for 28 seconds; this sequence repeating for 5 minutes each hour. Performance was measured by the number of pulses until the 1500 mW load voltage reached 1.05 V. The results are provided in Tables 3-5 below.

TABLE 3
AA battery performance for batteries including various electrolyte compositions.

| | | Control | Control | Electrolyte | Electrolyte |
|---|---|---|---|---|---|
| Test | | A | B | I | II |
| ANSI/IEC - motorized toys | Average | 8.68 | 9.12 | 9.72 | 9.69 |
| cell run at 3.9 ohm for 1 h/day, rest for 23 | Standard | 0.26 | 0.13 | 0.11 | 0.07 |
| h/day, continued until cell reached 0.8 V | Deviation | | | | |
| cathode voltage (service hours) | number of | 8 | 8 | 5 | 5 |
| | samples | | | | |
| ANSI/IEC - remote controls | Average | 48.65 | 49.3 | 52.51 | 52.21 |
| 24 Ohm at 15 sec/min, run for duration of | Standard | 1.36 | 1.75 | 1.35 | 0.72 |
| 8 h/d, until 1.0 V cathode voltage (service | Deviation | | | | |
| hours) | number of | 8 | 8 | 5 | 5 |
| | samples | | | | |
| ANSI - portable light | Average | 7.23 | 7.34 | 8.07 | 7.94 |
| 3.3 Ohm at 4 min/hour for 8 h/d, until | Standard | 0.17 | 0.46 | 0.05 | 0.13 |
| 0.9 V cathode voltage (service hours) | Deviation | | | | |
| | number of | 8 | 8 | 5 | 5 |
| | samples | | | | |
| ANSI-digital cameras (Pulses to 1.05 V) | Average | 638.3 | 437.3 | 600 | 506 |
| 1500 for 2 s, followed by 650 mW for | Standard | 8.1 | 10.2 | 12 | 9 |
| 28 s, repeated for 5 min/hour, until cell | Deviation | | | | |
| reaches 1.05 V cathode voltage (pulses) | number of | 8 | 8 | 5 | 5 |
| | samples | | | | |
| ANSI-CD players (and electric games) | Average | 12.29 | 12.51 | 12.62 | 12.57 |
| 0.25 A at 1 h/day, until 0.9 V cathode | Standard | 0.35 | 0.23 | 0.13 | 0.18 |
| voltage. (service hours) | Deviation | | | | |
| | number of | 8 | 7 | 5 | 5 |
| | samples | | | | |
| Clocks/ANSI/IEC-radios | Average | 88.54 | 85.1 | 94.77 | 95 |
| 43 ohm at 4 h/day, until 0.9 V cathode | Standard | 1.45 | 3.69 | 6.45 | 1.69 |
| voltage (service hours) | Deviation | | | | |
| | number of | 8 | 8 | 5 | 5 |
| | samples | | | | |

TABLE 4
Comparison of the performance of AA battery including
Electrolyte I or Electrolyte II to the performance
of AA battery including Control A

| Test | Electrolyte I |
|---|---|
| ANSI/IEC - motorized toys | +11.98% |
| 3.9 ohm, 1 hour/day, 0.8 V cathode voltage | |
| ANSI/IEC - remote controls | +7.93% |
| 24 Ohm, 15 sec/min - 8 h/d, 1.0 V cathode voltage | |
| ANSI - portable light | +11.62% |
| 3.3 Ohm 4 min/hour; 8 h/d to 0.9 V cathode voltage | |
| ANSI-digital cameras (Pulses to 1.05 V) | −6% |
| 1500/650 mW 2 s/30 s 5 min/hour, 1.05 V cathode voltage | |
| ANSI-CD players (and electric games) | +2.69% |
| 0.25 A, 1 hour/day, 0.9 V cathode voltage. | |
| Clocks/ANSI/IEC-radios | +7.04% |
| 43 ohm, 4 hours/day, 0.9 V cathode voltage. | |

TABLE 5
Comparison of the performance of AA battery including Electrolyte
II to the performance of AA battery including Control B.

| Test | Electrolyte II |
|---|---|
| ANSI/IEC - motorized toys | +6.25% |
| 3.9 ohm, 1 hour/day, 0.8 V cathode voltage | |
| ANSI/IEC - remote controls | +5.9% |
| 24 Ohm, 15 sec/min - 8 h/d, 1.0 V cathode voltage | |
| ANSI - portable light | +8.17% |
| 3.3 Ohm 4 min/hour; 8 h/d to 0.9 V cathode voltage | |
| ANSI-digital cameras (Pulses to 1.05 V) | +15.71% |
| 1500/650 mW 2 s/30 s 5 min/hour, 1.05 V cathode voltage | |
| ANSI-CD players (and electric games) | +0.48% |
| 0.25 A, 1 hour/day, 0.9 V cathode voltage. | |
| Clocks/ANSI/IEC-radios | +11.63% |
| 43 ohm, 4 hours/day, 0.9 V cathode voltage. | |

As shown in Tables 4-5, in general, for the majority of performance tests, batteries filled with Electrolytes I showed comparable or better performance as batteries filled with Control A electrolyte, even though total salt concentrations in Electrolyte I was 0.25 M lower than that in Control A.

Referring to Tables 4 and 6, batteries filled with Electrolyte II exhibited superior performance compared to batteries filled with Control B, even though the total salt concentration is 0.15 M lower. Performance improvement varied from 0.5% to 16% depending on tests.

### Other Embodiments

While certain embodiments have been described, other embodiments are possible. For example, in some embodiments, the electrolyte compositions described herein above is applicable to other lithium batteries, such as batteries including a cathode/anode couple of Cu₂S/L₁, CFₓ/Li, CuO/Li, or O₂/Li. In some embodiments, instead of an anode including only Li, the anodes can be made out of Li alloys with carbon, Si, Sn, or mixtures thereof.

All references, such as patent applications, publications, and patents, referred to herein are incorporated by reference in their entirety.

Other embodiments are within the claims.

What is claimed is:

1. A battery, comprising a housing, and within the housing:
(a) an anode comprising a lithium-containing anode active material;
(b) a cathode comprising a transition metal sulfide or a transition metal oxide; and
(c) an electrolyte comprising between 0.05 M and 0.5 M lithium iodide, between 0.05 M and 0.5 M lithium hexafluorophosphate, 30% by weight or more 1,3-dioxolane, and 20% by weight or more 1,2-dimethoxyethane.

2. The battery of claim 1, wherein the cathode comprises one or more of FeS₂, FeS, and CuS.

3. The battery of claim 2, wherein the cathode comprises FeS₂.

4. The battery of claim 1, wherein the electrolyte further comprises water.

5. The battery of claim 4, wherein the electrolyte comprises less than 500 ppm water.

6. The battery of claim 5, wherein the electrolyte comprises between 50 ppm and 500 ppm water.

7. The battery of claim 1, wherein the electrolyte further comprises an additive.

8. The battery of claim 7, wherein the additive is 3,5-dimethylisoxazole or pyridine.

9. The battery of claim 8, wherein the electrolyte comprises between 500 ppm and 5000 ppm 3,5-dimethylisoxazole.

10. The battery of claim 8, wherein the electrolyte comprises between 500 ppm and 5000 ppm pyridine.

11. The battery of claim 1, wherein the electrolyte comprises between 0.05 M and 0.3 M LiI.

12. The battery of claim 1, wherein the electrolyte comprises between 0.05 M and 0.3 M LiPF₆.

13. The battery of claim 1, wherein the electrolyte comprises 70% by weight 1,3-dioxolane.

14. The battery of claim 1, wherein the electrolyte comprises 30% by weight 1,2-dimethoxyethane.

15. The battery of claim 1, wherein the electrolyte has a viscosity of between 0.6 and 0.8 cps.

16. The battery of claim 1, wherein the electrolyte has a resistivity of between 100 and 600 ohm·cm.

17. The battery of claim 1, wherein the battery has a specific discharge capacity of 3.86 Ah or less after predischarge.

18. The battery of claim 1, further comprising a separator within the housing, wherein the separator has a porosity of between 35% and 65%.
